(19) United States
(12) Patent Application Publication
(10) Pub. No.: US 2006/0137231 A1
(43) Pub. Date: Jun. 29, 2006

(54) Rotatable sign

(76) Inventor: Jonathan James Ferguson Phillips, Christchurch (NZ)

Correspondence Address: MCCORMICK, PAULDING & HUBER LLP, CITY PLACE II, 185 ASYLUM STREET, HARTFORD, CT, 06103, US

(21) Appl. No.: 10/542,309

(22) PCT Filed: Feb. 5, 2004
(86) PCT No.: PCT/NZ04/00023

§ 371 Date: Jul. 15, 2005

(30) Foreign Application Priority Data
Feb. 7, 2003 (NZ) 524092
Mar. 24, 2003 (NZ) 524908

(51) Int. Cl. G09F 19/00

(52) U.S. Cl. 40/430

(57) ABSTRACT

A rotatable sign which consists of at least one rotatably sign portion mounted upon an axle, a base to which one end of the axle is secured, and means for limiting the rotational speed of the rotatable sign portion, preferably in the form of braking means which applies an increasing braking force to the sign as the speed of rotation of the sign increases.

The present invention relates to a rotatable sign used for advertising purposes.

### TECHNICAL FIELD

Rotatable signs are well-known, most commonly in the form of footpath signs in which the rotating portion of the sign is carried on a weighted base. However, the existing designs of rotatable sign have a significant drawback in that the speed of rotation of the sign is completely dependent upon wind speed, and in high winds the sign may rotate so rapidly that it is unreadable and/or the sign may be damaged, or cause injury to bystanders.

### DISCLOSURE OF INVENTION

It is therefore an object of the present invention to provide a design for a rotatable sign which overcomes the above described drawbacks.

The present invention provides a rotatable sign which includes a first sign portion which is rotatably mounted, and means for limiting the rotational speed of said first sign portion.

Preferably said means for limiting the rotational speed of said first sign portion comprises braking means arranged to apply a braking force to said first sign portion, said braking means being such that said braking force increases as the speed of rotation of said first sign portion increases.

Preferably, the sign also includes a base and the first sign portion includes two opposed sides each adapted to carry advertising material, said sides being secured one on each side of a substantially vertical axle which extends parallel to the longitudinal axes of the sides, and has its lower end mounted in the base.

The axle may be rigidly mounted onto the base, with the first sign portion mounted on bearings on the axle; alternatively, the first sign portion may be rigidly mounted on the axle and the lower end of the axle rotatably mounted on the base.

Preferably, the base is weighted or water filled. The base may also be adapted to store electrical batteries, and preferably incorporates one or more rollers and provides sockets for receiving a handle.

Preferably, the braking means includes an arm which is pivotably secured to the first sign portion such that the centrifugal force generated by rotational movements of the first sign portion in use causes the arm to pivot in a pre-determined direction; the arm is connected to a brake pad so that the pivotable movement of the arm moves the brake pad into frictional contact with a stationary surface, which may be a plate rigidly secured to the axle (if the axle is stationary) or the upper surface of the base (if the axle is rotatable).

Preferably, the braking means also includes means for adjusting the position of the arm at which the brake pad is brought into frictional contact with the stationary surface.

Preferably, the sign also includes a second sign portion which is mounted upon one end of the axle and may be moveable between a first non-rotatable position and a second position in which it is rotatably secured to the first sign portion. The second sign portion may be adapted to be electrically illuminated.

### BRIEF DESCRIPTION OF DRAWINGS

By way of example only, preferred embodiments of the present invention are described in detail with reference to the accompanying drawings in which:—

FIG. 1 shows a partly sectioned side view of a footpath sign in accordance with a first embodiment of the present invention, with the speed control in a first position;

FIG. 2 shows a view similar to FIG. 1, but with the speed control in a second position;

FIG. 3 shows a side view of the speed control on a larger scale;

FIG. 4 shows a plan view of the rotating portion of the sign;

FIG. 5 shows a plan view of the base;

FIG. 6 shows a side view of the base;

FIG. 7 shows a longitudinal section through a sign in accordance with a second embodiment of the invention;

FIG. 8 shows a plan view of the brake means of FIG. 7 on a larger scale; and

FIG. 9 shows a side view of a third embodiment, with one sign panel removed.

### BEST MODE FOR CARRYING OUT THE INVENTION

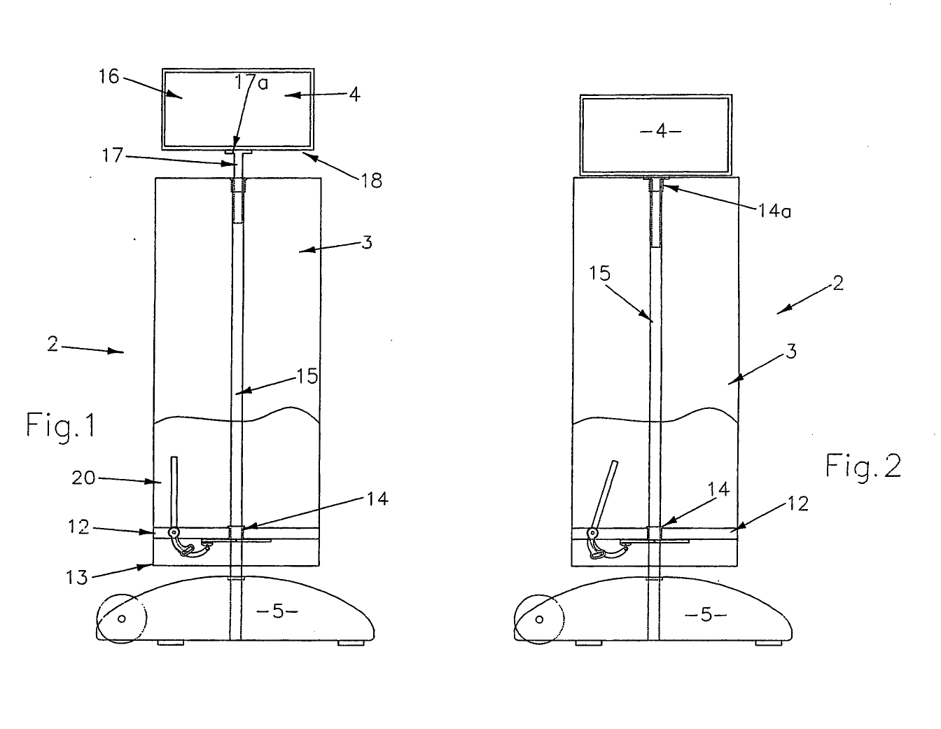

Referring to FIGS. 1-6 of the drawings, a rotatable sign 2 comprises a rotatable first sign portion 3, an upper second sign portion 4 and a base 5.

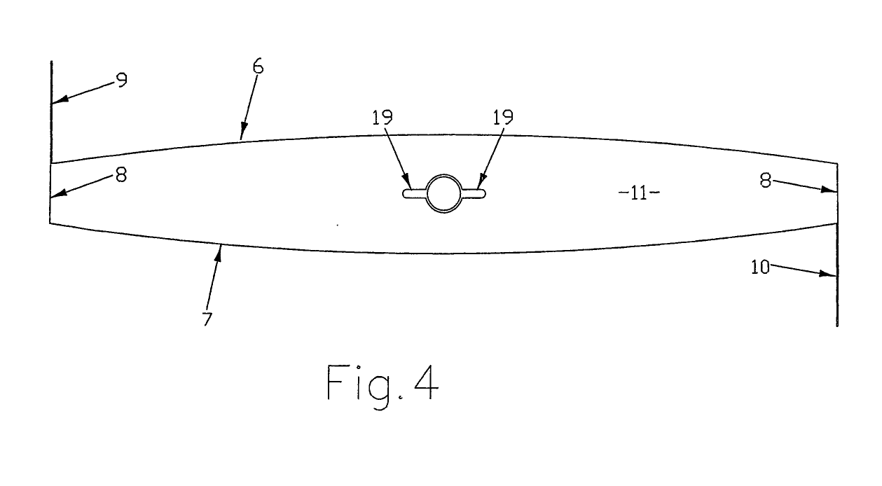

Referring in particular to FIG. 4, the rotatable sign portion 3 consists of two opposed rectangular sheets 6,7 secured together along their vertical edges by end plates 8. The sheets 6,7 are bowed outwards from each other over the central portion of the sign. A wing 9,10 of stiff but resilient material is secured along the full length of each vertical edge, with the plane of the wing coincident with the corresponding end plate 8. The wings 9,10 extend in opposite directions i.e. one adjacent the sheet 6 and the other adjacent the sheet 7. The upper surface of the sign is finished with a top plate 11.

In use, each sheet 6,7 may carry advertising material which may be printed directly on the sheets 6,7 or carried on removable panels (not shown) mounted on the sheets 6,7.

A reinforcing bar 12 is mounted across the width of the rotatable sign portion 3, a short distance above the lower edge 13 of the portion 3. The bar 12 carries a bearing 14 at its midpoint. A vertical axle 15 in the form of a hollow rigid tube is supported adjacent the top plate 11 of the rotatable sign portion 3 by a ball bearing 14a, extends down the full height of the rotatable sign portion 3 and passes through the bearing 14 to project a short distance below the lower edge 13 of the rotatable sign portion 3; the lower end of the axle 15 is fitted into the central aperture 16 of the base 5 and may be locked to the base by any suitable means.

The upper sign portion 4 comprises a rectangular plate 16 mounted on a short post 17. Each side of the plate 16 may carry advertising material. In the position shown in FIG. 1, the upper sign portion 4 remains stationary when the rotatable sign portion 3 rotates, and the portion 4 is supported on top of the portion 3 by sliding the post 17 into the hollow top of the vertical axle 15.

In the position shown in FIG. 2, the upper sign portion 4 is pushed downwards towards the rotatable sign portion 3 until the lower edge 18 of the portion 4 contacts the upper plate 11 of the portion 3 and the crosspiece 17a formed on top of the axle 17 engages the slots 19 formed in the plate 11, locking the upper sign portion 4 to the portion 3 for rotation with that portion.

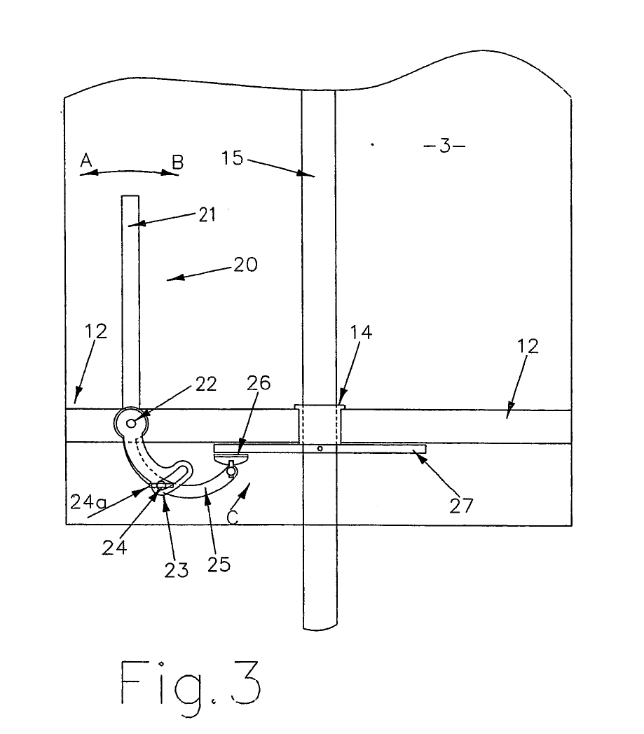

The reinforcing bar 12 also supports the control 20 for regulating the speed of rotation of the rotatable sign portion 3. The control 20 is shown on larger scale in FIG. 3, and consists of a lever 21 which is pivoted to the reinforcing bar 12 at a pivot 22 and which terminates in an adjuster 23. The adjuster comprises a slotted plate which receives a pin 24 rigidly secured to a brake lever 25; the head of the pin 24 carries a thumb screw 24a. The angle of the lever 21 relative to the brake lever 25 can be adjusted by slacking off the thumbscrew 24a, swinging the lever 21 in the direction of arrow A or arrow B until the lever 21 is at the desired position relative to the brake lever 25, and then tightening the thumb screw 24a to secure the lever 21 in that position.

The brake lever 25 is pivoted at one end on the pivot 22 and the other end carries a brake disk 26 which is arranged to bear upon the surface of a friction plate 27 which is rigidly secured to the axle 15.

When the rotatable sign portion 3 rotates in use, centrifugal force tends to throw the upper end of the lever 21 in a direction of arrow A. Since the lower end of the lever 21 is rigidly secured to the brake lever 25, this movement of the brake to the 21 tends to urge the brake disk 26 in the direction of arrow C, pressing the surface of the disk 26 into frictional contact with the friction plate 27, and thus braking the rotation of the sign portion 3.

The rotational speed of the rotatable sign portion 3 at which the braking effect starts is preselected by the starting position of the lever 21:—the more the upper end of the lever 21 is moved in the direction of arrow B, the higher the speed of rotation of the rotatable sign portion before the portion is braked.

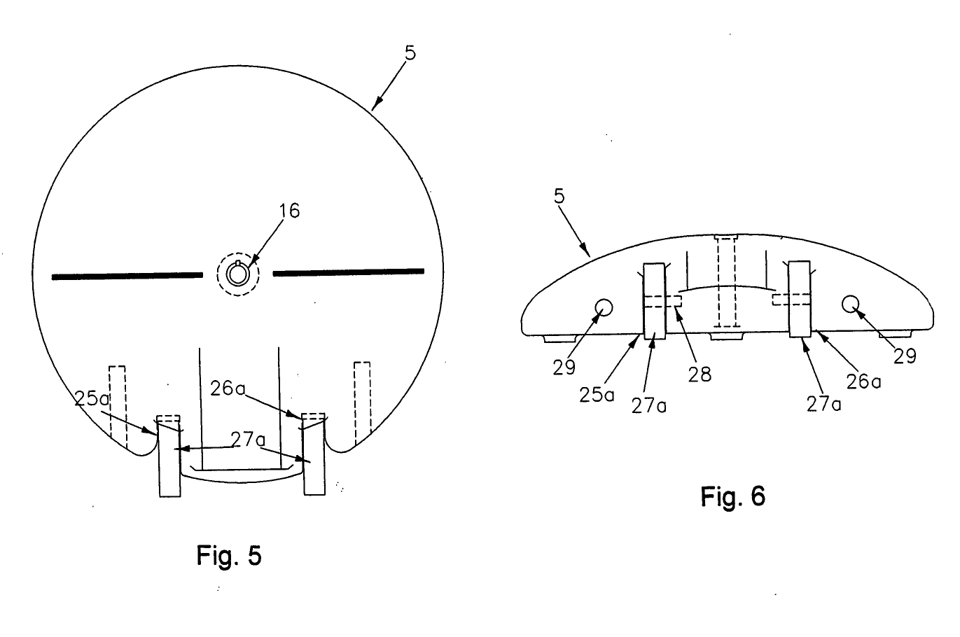

The base 5 is shown in detail in FIGS. 5 and 6 and comprises a plastics moulding which is circular in plan and which provides moulded-in apertures 25,26 to accommodate a pair of wheels 27 mounted upon an axle 28. The base 5 also may be formed with apertures 29 to receive the ends of a handle which can be used to tilt the whole sign onto the wheels 27, so that the sign can be moved easily.

The base 5 is weighted or can be adapted to be water filled. The base 5 also may accommodate batteries so that the rotatable sign portion can be illuminated, and a safety cable or chain so that the sign can be secured in position.

The above described rotatable sign also may be secured to a surface, rather than used on the base 5. In this case, the lower end of the axle 15 is received in a socket formed on the surface to which the sign is to be secured.

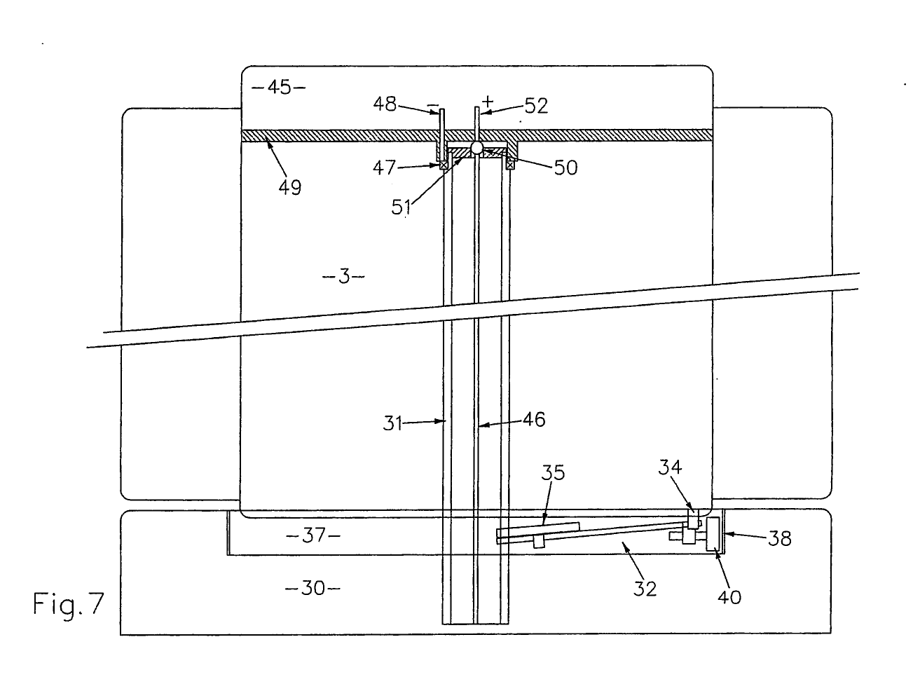

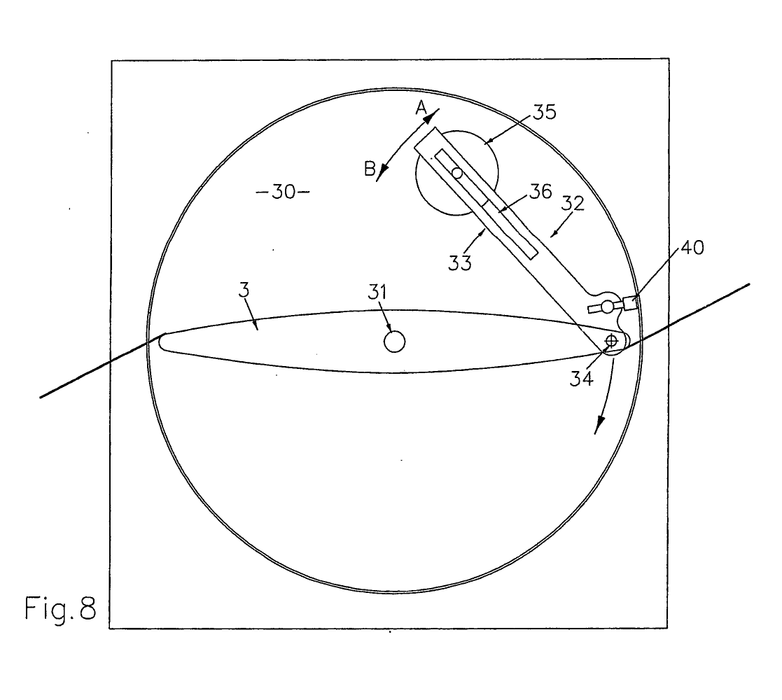

Referring to FIGS. 7 and 8 of the drawings, in a second embodiment of the invention, a drum brake arrangement is designed to control the speed of rotation of the rotatable sign portion 3 relative to the stationary base 30. The rotatable sign portion 3 is mounted for rotation relative to the base 30 on a hollow axle 31; the axle 31 is mounted in bearings (not shown) in the base in known manner.

As shown on an enlarged scale in FIG. 8, the drum brake arrangement 32 consists of a control arm 33 which is pivotally secured to the lower edge of the sign 3 by an inclined pin 34; the arm 33 is inclined downwards at an acute angle to the lower edge of the sign 3.

The free end of the arm 33 carries a weight 35 which can be varied in position along the length of the arm 33 by sliding the weight 35 along a slot 36 in the arm 33 and securing the weight 35 in the required position along the length of the arm 33. Adjacent the pin 34, the arm 33 carries a brake pad 40.

The surface of the base 30 immediately beneath the lower edge of the sign 3 is formed with a circular cross section depression 37 concentric with the axle 31, to accommodate the arm 33, weight 35 and brake pad 40, without these items being visible on the outside of the sign:—the edge of the depression 37 stops short of the edge of the base 30.

The brake pad 40 is arranged with the braking surface of the disc space a short distance away from the wall 38 of the depression 37. When the brake is in the inactive position shown in FIG. 8, the angle of inclination of the arm 33 and the weight of the arm 33 and the weight 35 draw the brake pad 40 away from the wall 38, so that there is no braking of the sign. However, as the sign 3 rotates, centrifugal force moves the weight 35 and the attached arm 33 in the direction of Arrow A, thus bringing the brake pad 40 into braking contact with the wall 38 and slowing the rate of rotation of the sign.

The further towards the end of the slot 36 in the weight 35 is positioned, the greater the centrifugal force and the lower the speed of the sign 3 before the brake comes into effect. Moving the weight 33 down the length of the arm 33 towards the pin 34 permits the sign to achieve a greater speed of rotation before the brake comes into effect.

It will be appreciated that the braking means and the base described with reference to FIGS. 7 and 8 could be used with a sign of the type described with reference to FIGS. 1-6, and the braking means described with reference to FIGS. 1-6 could be fitted to the sign of FIGS. 7 and 8.

Referring to FIG. 7, the arrangement for providing electrical illumination to the other portion 45 of the sign 3 is shown diagrammatically. The portion 45 may remain stationary while the main portion 3 of the sign rotates or may be arranged to rotate with the sign 3.

Power may be supplied to the sign from the mains or from batteries (not shown) stored in the base 30. In either case, one terminal is connected to the axle 31 and the other to a wire 46 which passes through the centre of the hollow axle 31. The other end of the axle 31 is in electrical contact with a metal roller bearing 47 which is in electrical contact with a metal post 48 which extends vertically between the sign 45 and the bearing 47, through an electrically insulating layer 49, to provide a negative terminal in the sign.

The wire 46 is in electrical contact with a single ball bearing 15 which is mounted in a layer of insulation 51 on the top of the axle 31 and provides an electrical connection to a positive terminal 52 which extends through the insulating layer 49 and into the interior of the sign 45. The sign illumination is connected to the positive and negative terminals in known manner.

The sign has been described as it is most commonly used, i.e. with the base resting on the ground or other supporting surface and the sign portion or portions above the base. However, it will be appreciated that the sign could be used with the base secured to an elevated supporting surface, with the sign portions below the base.

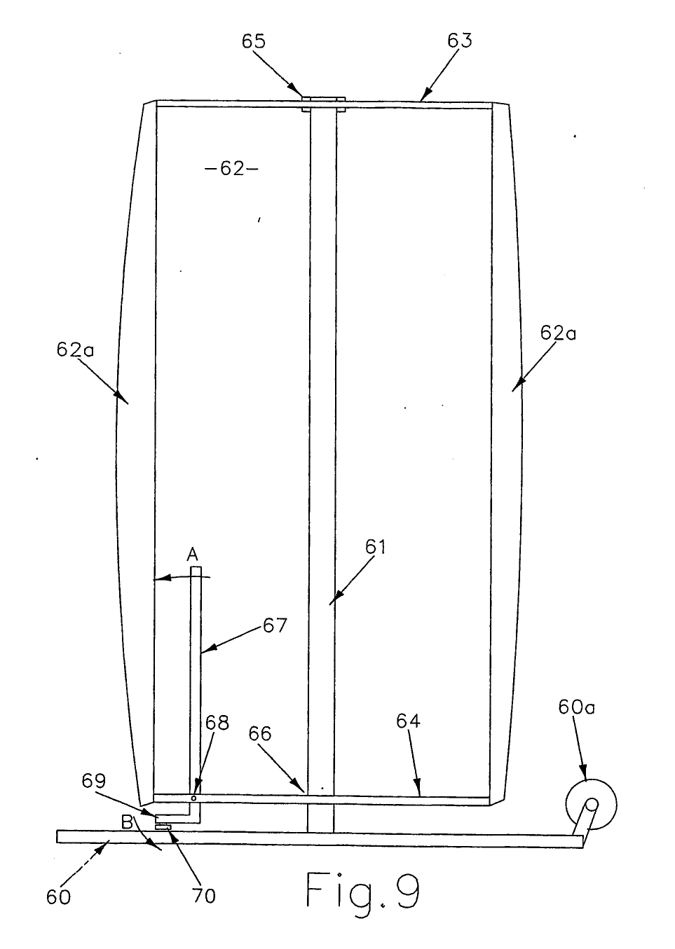

FIG. 9 shows a third embodiment of the invention. In this embodiment, the base 60 is a flat plate of heavy material, (e.g. steel) and the lower end of the axle 61 is rigidly secured to the centre of the base. The base is fitted with a wheel 60a.

A rotatable sign portion in the form of a pair of opposed sign portions 62 (one of which is shown removed to expose the braking mechanism) is secured between upper and lower supports 63,64. The sign portions 62 are fitted with wing portions 62a, as in the first and second embodiments. The upper support 63 comprises a plate which is mounted upon the axle 61 in a bearing 65, so that the sign portions and upper and lower supports can rotate freely upon the axle 61. There is no lower bearing:—the whole rotatable sign portion is supported upon the bearing 65.

The lower support 64 consists of a plate formed with a hole 66 to accommodate the axle 61 and a slot (not visible) through which a control arm 67 passes. The control arm 67 is L-shaped in side view and is pivoted to the support 64 by a pivot pin 68 which passes through a bore through the thickness of the plate. The pivot pin 68 passes through the arm 67 adjacent the lower end of the arm, so that the major portion of the arm 67 extends upwards.

The outer end 69 of the arm 67 below the support 64 carries a brake pad 70, of known type. When the rotatable sign portion rotates in use, the brake pad 70 moves around a circular track concentric with the axle 61. The base 60 carries a brake track (not visible) in the form of an annulus of aluminium or other suitable material, upon which the brake pad 70 can bear.

When the rotatable sign portion rotates, centrifugal force moves the upper end of the arm 67 in the direction of Arrow A, pivoting the outer end 69 and the brake pad 70 in the direction of Arrow B and thus urging the brake pad 70 into braking engagement with the brake track. The faster the rotatable sign portion rotates, the greater the centrifugal force, and the harder the brake pad 70 is pressed against the brake track. Thus, the braking force increases as the rate of rotation increases.

1. A rotatable sign which includes a first sign portion which is rotatably mounted, and means for limiting the rotational speed of said first sign portion.

2. The sign as claimed in claim 1, wherein said means for limiting the rotational speed of said first sign portion comprises braking means arranged to apply a braking force to said first sign portion, said braking means being such that said braking force increases as the speed of rotation of said first sign portion increases.

3. The sign as claimed in claim 1 or claim 2, wherein said first sign portion includes two opposed sides each adapted to carry advertising material, said sides being secured one each side of an axle which extends parallel to the longitudinal axes of said sides.

4. The sign as claimed in claim 3, further including a base; said axle being substantially vertical with its lower end mounted in said base.

5. The sign as claimed in claim 4, wherein said axle is rigidly mounted on said base and said first sign portion is mounted upon said axle upon at least one spaced bearing, said first sign portion being rotatable relative to said axle.

6. The sign as claimed in claim 4, wherein said first sign portion is rigidly mounted upon said axle and said lower end of said axle is rotatably mounted upon said base.

7. The sign as claimed in any one of claims 3-6, wherein each side of said first sign portion is provided with a wing of stiff but resilient material which extends outward at an angle to the corresponding side.

8. The sign as claimed in any one of claims 4-7, wherein the base is weighted.

9. The sign as claimed in any one of claims 4-7, wherein the base is adapted to be water filled in use.

10. The sign as claimed in any one of claims 4-8, wherein the base is adapted to store electrical batteries.

11. The sign as claimed in any one of claims 4-10, wherein the base incorporates one or more wheels upon its lower surface and provides sockets for receiving a handle.

12. The sign as claimed in any one of claims 4-11, wherein the braking means includes an arm pivotally secured to the first sign portion such that the centrifugal force generated by rotational movement of said first sign portion in use causes said arm to pivot in a predetermined direction.

13. The sign as claimed in claim 12, wherein said arm is connected to a brake pad such that said pivotal movement of said arm in said predetermined direction moves said brake pad into frictional contact with a stationary surface.

14. The sign as claimed in claim 13, wherein the braking means also includes means for adjusting the position of the arm at which the brake pad is brought into frictional contact with said stationary surface.

15. The sign as claimed in claim 13 or claim 14 when dependent upon claim 5, wherein said stationary surface comprises a plate rigidly secured to said axle.

16. The sign as claimed in claim 13 or claim 14 when dependent upon claim 6, wherein said stationary surface comprises a wall of a depression formed in the upper surface of said base.

17. The sign as claimed in claim 13, wherein said stationary surface comprises the upper surface of said base.

18. The sign as claimed in any one of claims 3-16, further including a second sign portion mounted upon one end of said axle.

19. The sign as claimed in claim 5, further including a second sign portion mounted upon one end of said axle, said second sign portion being movable between a first position in which said second sign portion is non-rotatably secured to said axle and a second position in which said second sign portion is releasably secured to said first sign portion for rotation therewith.

20. The sign as claimed in claim 6, further including a second sign portion mounted upon one end of said axle so as to be rotatable therewith.

21. The sign as claimed in claim 20 further including an electrical connection between said second sign portion and electricity supply means connected to or mounted in said base.
